(19) United States
(12) Patent Application Publication
(10) Pub. No.: US 2025/0086697 A1
(43) Pub. Date: Mar. 13, 2025

(54) SYSTEM FOR CO-OWNING WATERCRAFT, COMPUTER, AND METHOD OF CO-OWNING WATERCRAFT

(71) Applicant: YAMAHA HATSUDOKI KABUSHIKI KAISHA, Iwata-shi (JP)

(72) Inventors: Hiroshi INOUE, Shizuoka (JP); Tomoaki SATO, Shizuoka (JP)

(21) Appl. No.: 18/882,881

(22) Filed: Sep. 12, 2024

(30) Foreign Application Priority Data
Sep. 13, 2023 (JP) 2023-148321

(51) Int. Cl. G06Q 30/0645; B60R 25/24; G06K 7/10; G06K 19/07; G06Q 10/20; G06Q 20/10

(52) U.S. Cl. CPC G06Q 30/0645; B60R 25/24; G06K 7/10366; G06K 19/0723; G06Q 10/20; G06Q 20/102; B60R 2325/304

(57) ABSTRACT

A system for co-owning a watercraft having a unique watercraft ID includes a computer configured or programmed to obtain and store information regarding co-owning the watercraft, and a communication module having a unique communication module ID. The communication module is attachable to the watercraft and operable to communicate with the computer and store information regarding the watercraft. The computer is configured or programmed to store the watercraft ID and the communication module ID in association with each other, to communicate with communication terminals used by co-owners of the watercraft, and provide one of the communication terminals with the information regarding the watercraft received from the communication module in response to a request from the one of the communication terminals.

### CROSS REFERENCE TO RELATED APPLICATIONS

This application claims the benefit of priority to Japanese Patent Application No. 2023-148321 filed on Sep. 13, 2023. The entire contents of this application are hereby incorporated herein by reference.

### BACKGROUND OF THE INVENTION

### 1. Field of the Invention

The present invention relates to systems for co-owning watercraft, computers, and methods of co-owning watercraft.

### 2. Description of the Related Art

There has been conventionally disclosed a system for co-purchasing a merchandise such as a watercraft and then managing the co-purchased merchandise (see Japan Laid-open Patent Application Publication No. 2002-312625).

When a person co-purchases and then co-owns a watercraft with one or more others, for instance, there is a concern that management of the watercraft is complicated. For example, there are chances that any of the co-owners does not pay a maintenance fee for the watercraft and/or that any of the co-owners sells the watercraft without permission of the remaining co-owners. This poses a problem such that people are reluctant to co-purchase or co-own watercraft with one or more others.

### SUMMARY OF THE INVENTION

Example embodiments of the present invention provide systems, computers, and methods so that people are able to co-own watercraft without worries.

According to an example embodiment of the present invention, a system for co-owning a watercraft having a unique watercraft ID includes a computer configured or programmed to obtain and store information regarding co-owning the watercraft, and a communication module having a unique communication module ID. The communication module is attachable to the watercraft, and is operable to communicate the computer and store information regarding the watercraft. The computer is configured or programmed to store the watercraft ID and the communication module ID in association with each other, communicate with communication terminals used by co-owners of the watercraft, and provide one of the communication terminals with the information regarding the watercraft received from the communication module in response to a request from the one of the communication terminals.

In the system for co-owning a watercraft according to an example embodiment, the computer is configured or programmed to store the watercraft ID and the communication module ID in association with each other. Thus, it is possible to simplify management of the watercraft. Additionally, the information regarding the watercraft, received by the computer from the communication module, is provided to the one of the communication terminals in response to the request from the one of the communication terminals. Thus, it is possible for the co-owners to, for instance, easily understand a usage status of the watercraft and/or information of the present location of the watercraft. Because of this, it is possible for the co-owners to co-own the watercraft without worries.

A computer according to another example embodiment of the present invention is used for co-owning a watercraft, and includes a storage, a central processing unit, and a watercraft information provider. The storage obtains and stores information regarding co-owning the watercraft. The central processing unit is configured or programmed to store a unique watercraft ID and a unique communication module ID in association with each other. The unique watercraft ID is assigned to the watercraft, and the unique communication module ID is assigned to a communication module that is attachable to the watercraft and operable to store information regarding the watercraft. The watercraft information provider provides one of communication terminals used by co-owners of the watercraft with the information regarding the watercraft received from the communication module in response to a request from the one of the communication terminals.

A method of co-owning a watercraft according to yet another example embodiment of the present invention is executable by a computer and includes obtaining and storing information regarding co-owning the watercraft, storing a unique watercraft ID assigned to the watercraft and a unique communication module ID assigned to the communication module that is attachable to the watercraft and operable to store information regarding the watercraft in association with each other, and providing one of communication terminals used by co-owners of the watercraft with the information regarding the watercraft received by the computer from the communication module in response to a request from the one of the communication terminals.

According to example embodiments of the present invention it is possible to provide systems, computers, and methods to make it possible for co-owners to co-own watercraft without worries.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram showing a system for co-owning a watercraft according to an example embodiment of the present invention.

FIG. 2 is a functional block diagram of the system for co-owning a watercraft.

FIG. 3 is a flowchart showing a configuration of processes executed in a cloud server.

FIG. 4 is a flowchart showing another configuration of processes executed in the cloud server.

FIG. 5 is a flowchart showing yet another configuration of processes executed in the cloud server.

### DETAILED DESCRIPTION OF THE EXAMPLE EMBODIMENTS

Example embodiments of the present invention will be hereinafter explained with reference to drawings. A system 1 is provided for co-owning a watercraft 10 assigned with a unique watercraft ID among a plurality of owners. The ownership of the watercraft 10 can be divided into predetermined shares and can be shared among the plurality of owners. The unique watercraft ID refers to an ID to identify the watercraft and may be, for instance, a watercraft identifying number.

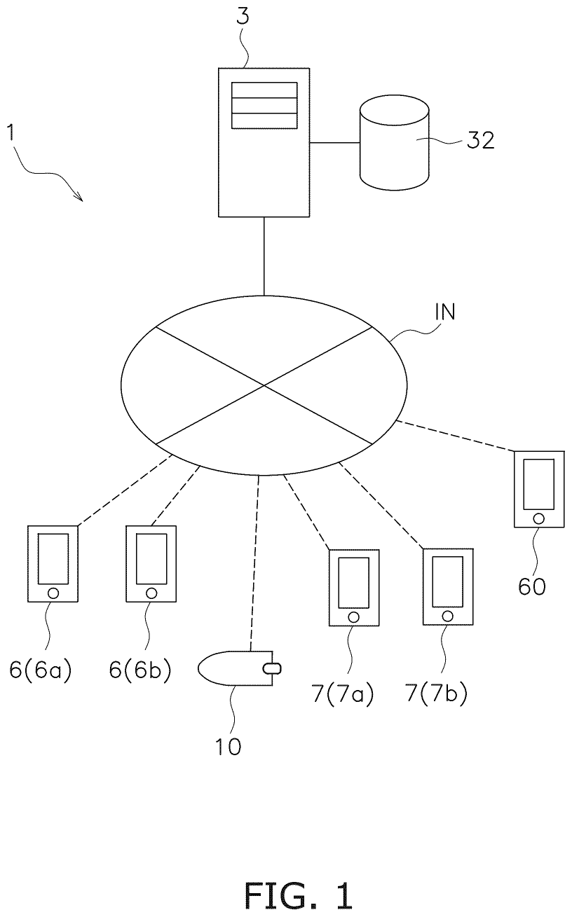

As shown in FIG. 1, the system 1 for co-owning the watercraft includes a cloud server 3 (an example of a computer) and a communication module 5.

The cloud server 3 is used for the transfer (including purchase and sale) of the ownership of the watercraft 10. The cloud server 3 is also used for the management of the watercraft 10 and distribution of revenue obtained from rental of the watercraft 10.

The cloud server 3 is configured or programmed to communicate with a plurality of purchase user terminals 6 and a plurality of co-ownership user terminals 7 (an example of communication terminals) over the Internet IN. The cloud server 3 is used to manage the plurality of purchase user terminals 6, the plurality of co-ownership user terminals 7, and the watercraft 10.

The plurality of purchase user terminals 6 and the plurality of co-ownership user terminals 7 are, for instance, communication terminals such as smartphones, tablet computers, desktop computers, laptop computers, wearable terminals, and/or so forth.

The plurality of purchase user terminals 6 are used by users who intend to co-own the watercraft 10. The plurality of purchase user terminals 6 are used by users who intend to purchase part of the ownership of the watercraft 10. In the present example embodiment, the plurality of purchase user terminals 6 include a first purchase user terminal 6a and a second purchase user terminal 6b.

The plurality of co-owner user terminals 7 are used by co-owners who have obtained part of the ownership of the watercraft 10. The plurality of co-owner user terminals 7 are used by users who already co-own the watercraft 10. In the present example embodiment, the plurality of co-owner user terminals 7 include a first co-ownership user terminal 7a and a second co-ownership user terminal 7b. For example, the first co-ownership user terminal 7a may be identical to the first purchase user terminal 6a. In other words, the co-owner of the watercraft 10, who has purchased part of the ownership of the watercraft 10 by using the first purchase user terminal 6a, may use the first purchase user terminal 6a as the first co-ownership user terminal 7a.

The term “information” will be used in the following explanation. The term “information” encompasses “data”.

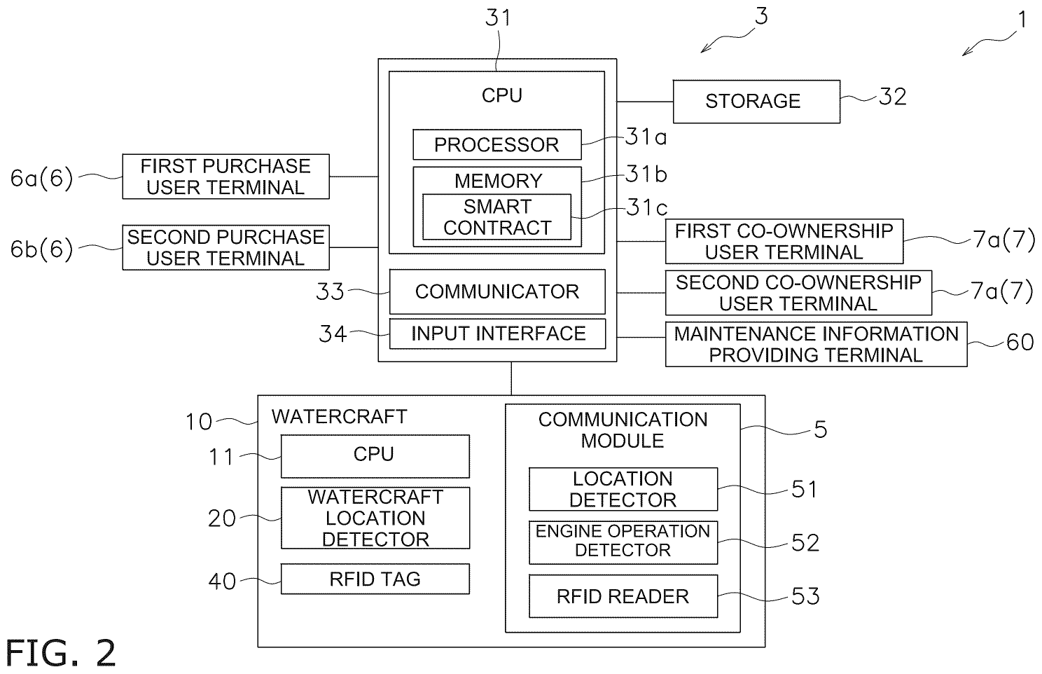

The cloud server 3 is managed by, for instance, a shipping agent. As shown in FIG. 2, the cloud server 3 includes a CPU 31, a storage 32, a communicator 33 (an example of a watercraft information provider), and an input interface 34.

The CPU 31 includes a processor 31a and a memory 31b (an example of a storage). The processor 31a processes a variety of information based on a variety of programs recorded in the memory 31b.

The memory 31b records the variety of information to be processed by the processor 31a and the variety of programs to be executed by the processor 31a. The memory 31b stores a smart contract 31c for processing the transfer of the ownership of the watercraft 10. In the present example embodiment, the smart contract 31c is a program executed on a blockchain and automatically executes a process such as a contract when a predetermined condition is satisfied. The memory 31b includes a volatile memory such as a RAM (Random Access Memory) and a non-volatile memory such as a ROM (Read Only Memory).

The storage 32 records a variety of information and a variety of programs. The storage 32 includes either or both of the following storage devices: an HDD (Hard Disk Drive) and an SSD (Solid State Drive). For example, the storage 32 is used as a database. The storage 32 may be included in the CPU 31.

The communicator 33 receives information and signals from the plurality of purchase user terminals 6, the plurality of co-owner user terminals 7, and the watercraft 10. The information, received by the communicator 33 from the plurality of purchase user terminals 6, the plurality of co-owner user terminals 7, and the watercraft 10 are recorded in the memory 31b.

The communicator 33 provides information and signals to the plurality of purchase user terminals 6, the plurality of co-owner user terminals 7, and the watercraft 10 in accordance with the information and signals received from the plurality of purchase user terminals 6, the plurality of co-owner user terminals 7, and the watercraft 10. The communicator 33 retrieves, from the memory 31b, information to be transmitted to the plurality of purchase user terminals 6, the plurality of co-owner user terminals 7, and the watercraft 10 when providing the information and signals to the plurality of purchase user terminals 6, the plurality of co-owner user terminals 7, and the watercraft 10.

The input interface 34 receives an input from a server administrator. Information and signals inputted to the input interface 34 are recognized by the processor 31a.

The communication module 5 may be a DCM (Data Communication Module). The communication module 5 is attached to the watercraft 10. The communication module 5 is operable to communicate with the cloud server 3 over the Internet IN. The communication module 5 is operable to communicate with the plurality of co-owner user terminals 7. The communication module 5 includes a processor such as a CPU and a memory unit including memories such as a RAM and a ROM. The memory unit stores information regarding the watercraft 10.

The communication module 5 has a unique communication module ID. The communication module ID is an ID to identify the communication module 5 and is uniquely assigned to the communication module 5.

The communication module 5 includes a location detector 51 and an engine operation detector 52. The location detector 51 detects location information of the communication module 5. The location detector 51 may be, for instance, a GPS (Global Positioning System) receiver. The location detector 51 obtains the location information of the communication module 5 from a GPS satellite. The communication module 5 transmits the location information, obtained by the location detector 51, to the cloud server 3. The cloud server 3 receives the location information of the communication module 5 through the communication module 5. The storage 32 in the cloud server 3 stores the location information of the communication module 5. The communication module 5 transmits the location information of the communication module 5 to the cloud server 3, for instance, in response to a request from one of the plurality of co-owner user terminals 7.

The engine operation detector 52 detects an operating state of an engine in the watercraft 10. The engine operation detector 52 may be, for instance, a sensor to detect the rotational speed of the engine.

Operating information of the engine includes time-series data regarding the rotational speed of the engine. The communication module 5 transmits the engine information, obtained by the engine operation detector 52, to the cloud server 3. The cloud server 3 receives the engine information through the communication module 5. The communication module 5 transmits the operating information of the engine to the cloud server 3, for instance, in response to a request from one of the plurality of co-owner user terminals 7.

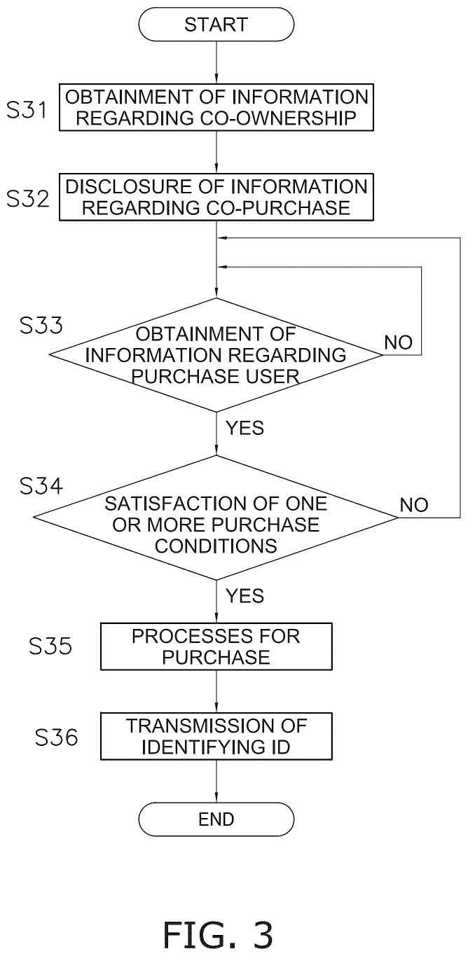

The cloud server 3 obtains and stores information regarding co-ownership of the watercraft 10 (step S31 in FIG. 3). The cloud server 3 obtains the information regarding co-ownership of the watercraft 10 by, for instance, receiving an input from the server administrator. The memory 31b of the CPU 31 in the cloud server 3 stores the obtained information regarding co-ownership of the watercraft 10.

The information regarding co-ownership of the watercraft 10 includes information regarding the watercraft ID of the watercraft 10 and the communication module ID of the communication module 5. The CPU 31 in the cloud server 3 associates the watercraft ID of the watercraft 10 and the communication module ID of the communication module 5 with each other and stores the pair of associated IDs in either the CPU 31 or the storage unit 32.

The information regarding co-ownership of the watercraft 10 includes, for instance, information regarding co-owners of the watercraft 10, information regarding share ratios of respective co-owners of the watercraft 10, and information regarding rights such as a revenue right and a use right of the watercraft 10.

The information regarding co-ownership of the watercraft 10 includes information regarding co-purchase of the watercraft 10. The information regarding co-purchase of the watercraft 10 includes at least one of a service status of the watercraft 10, revenue information of the watercraft 10, or a photograph of the watercraft 10. The information regarding co-purchase of the watercraft 10 may include co-purchase conditions indicating a share available for purchase and the price thereof, an evaluation of the watercraft 10 rated by a user of the watercraft 10, a maintenance fee of the watercraft 10, the share ratios of respective co-owners of the watercraft 10, and the information regarding rights such as the revenue right and the use right of the watercraft 10. The photograph of the watercraft 10 may include a photograph of the watercraft 10 taken by a user of the watercraft 10.

The cloud server 3 executes disclosure of the information regarding co-purchase of the watercraft 10 (step S32 in FIG. 3). For example, when the cloud server 3 is provided with the information regarding co-purchase of the watercraft 10 by the input from the server administrator, the CPU 31 in the cloud server 3 stores the provided information and executes disclosure of the information regarding co-purchase of the watercraft 10. The information regarding co-purchase of the watercraft 10 is disclosed on, for instance, a website provided by the cloud server 3.

For example, the cloud server 3 determines whether a first user using the first purchase user terminal 6a satisfies one or more purchase conditions (steps S33 and S34 in FIG. 3) when receiving the following information from the first user: information regarding the first user and information regarding a share to be purchased by the first user. When it is determined that the first user satisfies the one or more purchase conditions, the cloud server 3 automatically executes processes for purchase, including a process for payment and a process for transferring the ownership, by using the smart contract 31c (step S35 in FIG. 3). Likewise, the cloud server 3 determines whether a second user using the second purchase user terminal 6b satisfies the one or more purchase conditions when receiving the following information from the second user: information regarding the second user and information regarding a share to be purchased by the second user. When it is then determined that the second user satisfies the one or more purchase conditions, the cloud server 3 automatically executes the processes for purchase.

The cloud server 3 assigns individual identifying IDs to co-owners and provides the communication module 5 with the individual identifying IDs. For example, when the watercraft 10 is co-owned by two users (i.e., the first and second users), the cloud server 3 assigns individual identifying IDs to the first and second users, respectively, and transmits information regarding the individual identifying IDs to the communication module 5 (step S36 in FIG. 3). The communication module 5 stores the individual identifying IDs provided thereto from the cloud server 3. The individual identifying IDs, assigned to the first and second users, respectively, are stored in the communication module 5. It should be noted that, when a given user is one of the co-owners of the watercraft 10 but does not have the use right of the watercraft 10, for instance, the cloud server 3 does not provide the communication module 5 with the individual identifying ID of the given user. The following explanation will be made based on a premise that all the co-owners of the watercraft 10 (herein, the first and second users) have the use rights of the watercraft 10.

The communication module 5 is operable to communicate with the plurality of co-owner user terminals 7. When receiving, from one of the co-ownership user terminals 7, an unlock signal that serves to unlock a keylock of the watercraft 10 and includes the information regarding the individual identifying ID of the co-ownership user terminal 7, the communication module 5 executes unlocking the watercraft 10 based on the unlock signal. In the present example embodiment, the communication module 5 is operable to communicate with the first and second co-ownership user terminals 7a and 7b. When receiving, from the first or second co-ownership user terminal 7a, 7b, an unlock signal that serves to unlock the keylock of the watercraft 10 and includes the information regarding the individual identifying ID of the first or second co-ownership user terminal 7a, 7b, the communication module 5 executes unlocking the watercraft 10 based on the unlock signal.

The system 1 for co-owning a watercraft includes a watercraft location detector 20 and an RFID (Radio Frequency Identification) tag 40. In the present example embodiment, the communication module 5 includes the watercraft location detector 20.

The watercraft location detector 20 detects watercraft location information of the watercraft 10. The watercraft location detector 20 may be, for instance, a GPS receiver. The watercraft location detector 20 obtains the watercraft location information from a GPS satellite. A CPU 11 to control the watercraft 10 transmits the watercraft location information, obtained by the watercraft location detector 20, to the cloud server 3. The cloud server 3 receives the watercraft location information, obtained by the watercraft location detector 20, through the CPU 11 of the watercraft 10.

The RFID tag 40 is embedded in the watercraft 10. The RFID tag 40 stores the information regarding the watercraft 10. The communication module 5 includes an RFID reader 53 able to read the RFID tag 40. The RFID reader 53 is able to read the RFID tag 40 without being touched thereto. The RFID reader 53 regularly (periodically) loads the information from the RFID tag 40. The communication module 5 transmits a result of the reading by the RFID reader 53 to the cloud server 3.

The cloud server 3 provides the information regarding the watercraft 10, received from the communication module 5, to the first or second co-ownership user terminal 7a, 7b in response to a request from the first or second co-owner terminal 7a, 7b. The information regarding the watercraft 10 contains the location information of the communication module 5, the operating information of the engine, the watercraft location information of the watercraft 10, the information regarding the result of the reading by the RFID reader 53, the photograph of the watercraft 10 taken by the user of the watercraft 10, and so forth.

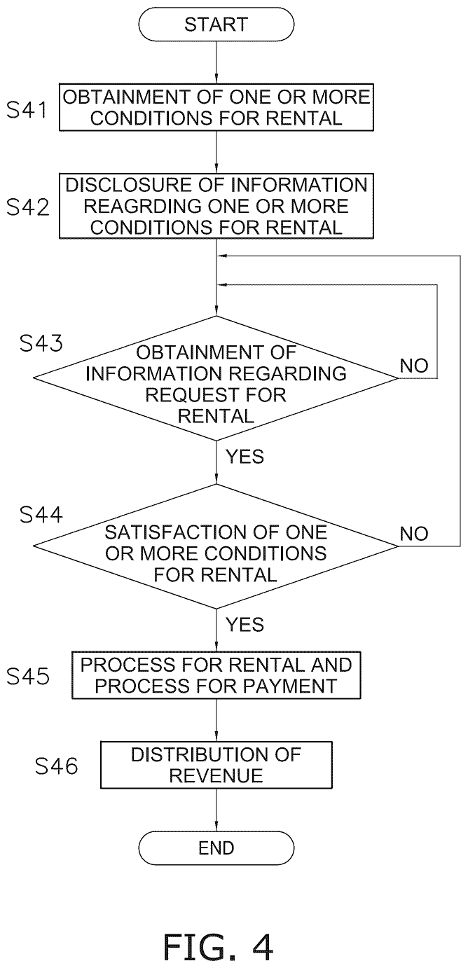

The cloud server 3 receives an input from the server administrator or one of the co-owners of the watercraft 10 and records information regarding one or more conditions for rental of the watercraft 10 (step S41 in FIG. 4). The cloud server 3 executes disclosure of the information regarding one or more conditions for rental of the watercraft 10 (step S42 in FIG. 4). The information regarding one or more conditions for rental of the watercraft 10 is disclosed on, for instance, the website provided by the cloud server 3.

When receiving information regarding a request for rental, which corresponds to a response to the information regarding one or more conditions for rental, from a user terminal of a rental user, i.e., a user intending to rent the watercraft 10, the cloud server 3 determines whether the rental user satisfies the one or more conditions for rental based on the information regarding a request for rental (steps S43 and S44 in FIG. 4). When it is determined that the rental user satisfies the one or more conditions for rental, the cloud server 3 automatically executes a process for rental and a process for payment by using the smart contract 31c (step S45 in FIG. 4).

After executing the process for rental of the watercraft 10, the cloud server 3 transmits the unlock signal to unlock the keylock of the watercraft 10 to the communication module 5. The cloud server 3 receives an input from the user terminal of the rental user. When it is determined that the user terminal of the rental user approaches to the watercraft 10 in response to the input from the user terminal of the rental user, the cloud server 3 transmits the unlock signal to the communication module 5.

The communication module 5 executes unlocking the watercraft 10 based on the unlock signal. When receiving information regarding termination of the rental from the user terminal of the rental user, the cloud server 3 transmits a lock signal to lock the keylock of the watercraft 10 to the communication module 5. When receiving the lock signal, the communication module 5 locks the keylock of the watercraft 10 based on the lock signal.

The system 1 for co-owning a watercraft distributes the revenue obtained by the rental of the watercraft 10 to the co-owners depending on the ratios of the ownership of the watercraft 10 held by the co-owners. The cloud server 3 distributes the revenue obtained by the rental of the watercraft 10 to the co-owners depending on the ratios of the shares of the watercraft 10 held by the co-owners. For example, the cloud server 3 monthly calculates the revenue obtained by the rental of the watercraft 10. The cloud server 3 executes the distribution process based on, for instance, information regarding a distribution destination set for each co-owner such as account information stored in the storage 32 (step S46 in FIG. 4). The cloud server 3 may execute the distribution process whenever the revenue is obtained by the rental of the watercraft 10.

The system 1 for co-owning a watercraft includes a maintenance information providing terminal 60. The maintenance information providing terminal 60 is used by a maintenance contractor in charge of maintenance of the watercraft 10. The maintenance information providing terminal 60 is operable to communicate with the cloud server 3. The maintenance information providing terminal 60 may be, for instance, a communication terminal such as a smartphone, a tablet computer, a desktop computer, a laptop computer, a wearable terminal, or so forth. For example, the storage 32 in the cloud server 3 associates a maintenance ID assigned to the maintenance contractor and either the watercraft ID or the communication module ID and stores the associated IDs.

The maintenance information providing terminal 60 provides the cloud server 3 with maintenance information of the watercraft 10. The maintenance information includes information regarding the content of a maintenance work for the watercraft 10. The maintenance information includes information regarding the maintenance fee for the watercraft 10. The information regarding the maintenance fee includes information regarding fuel calibration, fuel supply, and so forth.

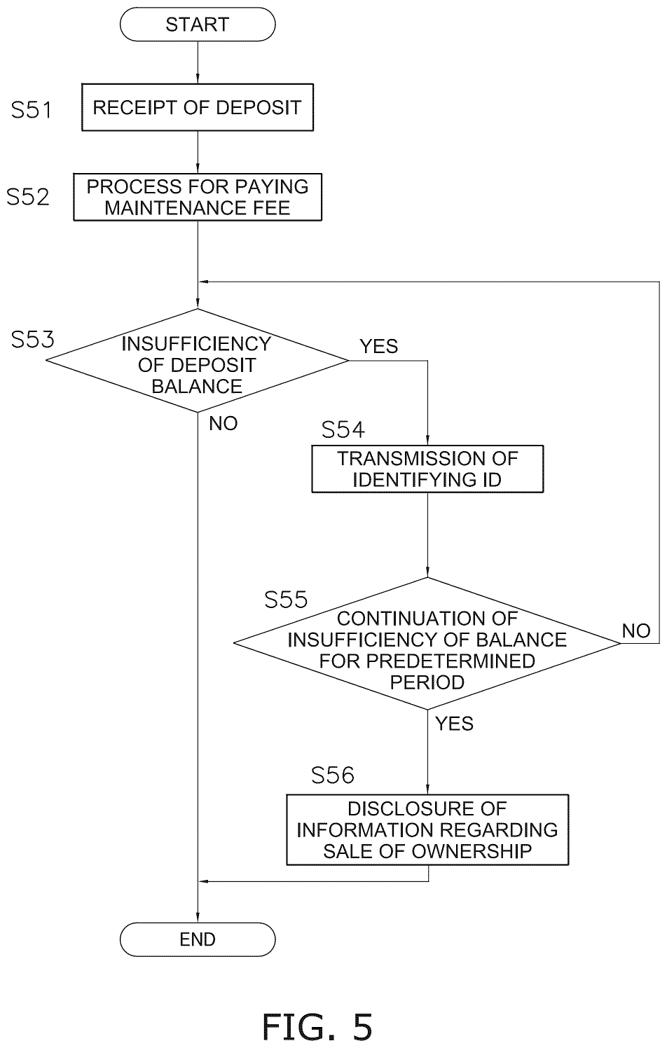

The cloud server 3 receives deposits from the co-owners of the watercraft 10 (step S51 in FIG. 5). The deposits from the co-owners of the watercraft 10 are managed by using the smart contract 31c. The cloud server 3 executes a process for paying the maintenance fee from the deposit based on the information regarding the maintenance fee provided thereto from the maintenance information providing terminal 60 (step S52 in FIG. 5).

The cloud server 3 sets allocation of the maintenance fee depending on ratios that the watercraft 10 has been used by the co-owners. For example, the cloud server 3 determines ratios of the maintenance fee to be borne by the first and second users depending on ratios that the watercraft 10 has been used by the first and second users.

The cloud server 3 monitors deposit balances (step S53 in FIG. 5). When a given co-owner has an insufficient deposit, the cloud server 3 provides the communication module 5 with the individual identifying ID of the given co-owner with the insufficient deposit (step S54 in FIG. 5). When it is determined that the deposit balance of the first user is less than or equal to a predetermined amount of money, for instance, the cloud server 3 provides the communication module 5 with the individual identifying ID of the first user. Additionally, the cloud server 3 informs the first user that the deposit of the first user is insufficient through the first co-ownership user terminal 7a.

The communication module 5 does not execute unlocking the watercraft 10 when receiving the unlock signal including the information regarding the identifying ID of the given co-owner with the insufficient deposit. Because of this, when the deposit balance of the first user is less than or equal to the predetermined amount of money, the first user is not allowed to unlock the watercraft 10. It should be noted that, when the first user resolves the insufficiency of the deposit balance, the communication module 5 clears any restrictions imposed on unlocking the watercraft 10 through the cloud server 3.

The cloud server 3 executes disclosure of information regarding sale of the ownership held by the given co-owner with the insufficient deposit. When it is determined that the deposit balance of the first user has continued to be insufficient for a predetermined period of time, for instance, the cloud server 3 executes disclosure of information regarding sale of the ownership of the watercraft 10 held by the first user (step S55 in FIG. 5). With the disclosure of the information regarding the sale of the ownership of the watercraft 10 held by the first user, the cloud server 3 executes disclosure of the information regarding the co-ownership of the watercraft 10 (step S56 in FIG. 5).

For example, when receiving information regarding a third user intending to co-own the watercraft 10 and information regarding a share to be purchased by the third user from a third purchase user terminal used by the third user, the cloud server 3 determines whether the third user satisfies the one or more purchase conditions. When it is determined that the third user satisfies the one or more purchase conditions, the cloud server 3 automatically executes the processes for purchase, including the process for payment and the process for transferring the ownership, by using the smart contract 31c. Accordingly, the share right of the watercraft 10 held by the first user is sold to the third user such that the ownership of the watercraft 10 is transferred from the first user to the third user.

At this time, when the maintenance fee to be borne by the first user has not been paid yet, the cloud server 3 executes a payment process by, for instance, compensating the maintenance fee with a sales proceed obtained by selling the share right of the watercraft 10 held by the first user and then paying the first user the amount of money resulted after deduction of the maintenance fee from the sales proceed.

In the system 1 for co-owning a watercraft described above, the cloud server 3 stores the watercraft ID and the communication module ID in association with each other. Thus, it is possible to simplify management of the watercraft 10. Additionally, the information regarding the watercraft 10, received by the cloud server 3 from the communication module 5, is provided to the first or second co-ownership user terminal 7a or 7b in response to the request from the first or second co-ownership user terminal 7a or 7b. Thus, it is possible for the co-owners to, for instance, easily understand a usage status of the watercraft 10 and/or information of the present location of the watercraft 10. Because of this, it is possible for the co-owners to co-own the watercraft without worries.

The number of purchase user terminals 6 may be greater than or equal to three. Likewise, the number of co-ownership user terminals 7 may be greater than or equal to three. The number of co-owners of the watercraft 10 may be greater than or equal to three.

The cloud server 3 may execute disclosure of the information regarding the sale of the ownership held by each co-owner, for instance, in response to receiving an input from the first or second co-ownership user terminal 7a, 7b.

In the example embodiments described above, both locking and unlocking of the keylock of the watercraft 10 are executed through the cloud server 3. However, both locking and unlocking of the keylock of the watercraft 10 may be executed by direct communication with the communication module 5 from each of the plurality of co-owner user terminals 7.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A system for co-owning a watercraft having a unique watercraft ID, the system comprising:
a computer configured or programmed to obtain and store information regarding co-owning the watercraft; and
a communication module having a unique communication module ID, attachable to the watercraft, and operable to communicate with the computer and store information regarding the watercraft; wherein
the computer is configured or programmed to:
store the watercraft ID and the communication module ID in association with each other;
communicate with communication terminals used by co-owners of the watercraft; and
provide one of the communication terminals with the information regarding the watercraft received from the communication module in response to a request from the one of the communication terminals.

2. The system according to claim 1, wherein
the information regarding co-owning the watercraft includes information regarding co-purchasing of the watercraft; and
the computer is configured or programmed to execute disclosure of the information regarding co-purchasing of the watercraft.

3. The system according to claim 2, wherein the information regarding co-purchasing of the watercraft includes at least one of a service status of the watercraft, revenue information of the watercraft, or a photograph of the watercraft.

4. The system according to claim 2, wherein the information regarding co-purchasing of the watercraft includes a photograph of the watercraft taken by a user of the watercraft.

5. The system according to claim 1, wherein
the computer is configured or programmed to assign individual identifying IDs to the co-owners and provide the individual identifying IDs to the communication module; and
the communication module is operable to store the individual identifying IDs provided thereto from the computer.

6. The system according to claim 5, wherein the communication module is operable to:
communicate with the communication terminals; and
unlock a keylock of the watercraft upon receiving an unlock signal from the one of the communication terminals to unlock the keylock of the watercraft, the unlock signal including information regarding the individual identifying ID of the co-owner of the one of the communication terminals.

7. The system according to claim 1, wherein the computer is configured or programmed to:
record information regarding a condition for rental of the watercraft; and
execute a process for rental of the watercraft based on information regarding a request for rental upon receiving the information regarding the request for rental from a user terminal of a user intending to rent the watercraft, the information regarding the request for rental corresponding to a response to the information regarding the condition for rental of the watercraft.

8. The system according to claim 7, wherein
the computer is configured or programmed to transmit an unlock signal to unlock a keylock of the watercraft to the communication module after executing the process for rental of the watercraft; and
the communication module is operable to execute unlocking the watercraft based on the unlock signal.

9. The system according to claim 7, wherein the computer is configured or programmed to distribute a revenue obtained by the rental of watercraft to the co-owners depending on ratios of the ownership of the watercraft held by the co-owners.

10. The system according to claim 1, further comprising:
a maintenance information providing terminal to provide information regarding a maintenance fee of the watercraft to the computer; wherein
the computer is configured or programmed to:
receive deposits from the co-owners; and
execute payment of the maintenance fee from the deposits based on the information regarding the maintenance fee of the watercraft provided thereto from the maintenance information providing terminal.

11. The system according to claim 10, wherein the computer is configured or programmed to set allocation of the maintenance fee depending on ratios that the watercraft has been used by the co-owners.

12. The system according to claim 10, wherein the computer is configured or programmed to:
assign individual identifying IDs to the co-owners;
provide the individual identifying IDs to the communication module; and
provide the individual identifying ID of one of the co-owners to the communication module when the one of the co-owners has an insufficient deposit; wherein
the communication module is operable to:
communicate with the communication terminals;
unlock a keylock of the watercraft upon receiving an unlock signal from the one of the communication terminals to unlock the keylock of the watercraft, the unlock signal including information regarding the individual identifying ID of the co-owner of the one of the communication terminals; and
not unlock the keylock of the watercraft upon receiving the unlock signal including the information regarding the individual identifying ID assigned to the one of the co-owners having the insufficient deposit.

13. The system according to claim 12, wherein the computer is configured or programmed to execute disclosure of information regarding sale of the ownership of the one of the co-owners having the insufficient deposit.

14. The system according to claim 1, wherein
the communication module includes a location detector to detect location information of the communication module; and
the computer is configured or programmed to receive the location information through the communication module.

15. The system according to claim 1, further comprising:
a watercraft location detector on the watercraft to detect watercraft location information of the watercraft; wherein
the communication module is operable to obtain the watercraft location information from the watercraft location detector; and
the computer is configured or programmed to receive the watercraft location information through the communication module.

16. The system according to claim 1, further comprising:
an RFID (Radio Frequency Identification) tag embedded in the watercraft and operable to store the information regarding the watercraft; wherein
the communication module includes an RFID reader to read the RFID tag.

17. The system according to claim 16, wherein the RFID reader is operable to read the RFID tag on a regular basis.

18. A computer used for co-owning a watercraft, the computer comprising:
a storage to obtain and store information regarding co-owning the watercraft;
a central processing unit configured or programmed to store a unique watercraft ID and a unique communication module ID in association with each other, the unique watercraft ID being assigned to the watercraft, the unique communication module ID being assigned to a communication module, and the communication module being attachable to the watercraft and operable to store information regarding the watercraft; and
a watercraft information provider to provide one of communication terminals used by co-owners of the watercraft with the information regarding the watercraft received from the communication module in response to a request from the one of the communication terminals.

19. A method of co-owning a watercraft, the method being executable by a computer and comprising:
obtaining and storing information regarding co-owning the watercraft;
storing a unique watercraft ID and a unique communication module ID in association with each other, the unique watercraft ID being assigned to the watercraft, the unique communication module ID being assigned to a communication module, and the communication module being attachable to the watercraft and operable to store information regarding the watercraft; and
providing one of communication terminals used by co-owners of the watercraft with the information regarding the watercraft received by the computer from the communication module in response to a request from the one of the communication terminals.
